(19) United States
(12) Patent Application Publication
(10) Pub. No.: US 2026/0055829 A1
(43) Pub. Date: Feb. 26, 2026

(54) Wall Thimble Alignment Trim and Wall Thimble Assembly Having an Alignment Trim for a Chimney

(71) Applicant: Jeremias Inc., Marietta, GA (US)

(72) Inventors: Clark E. Pridemore, Woodstock, GA (US); Victor Prado, Atlanta, GA (US)

(21) Appl. No.: 19/309,545

(22) Filed: Aug. 25, 2025

Related U.S. Application Data
(60) Provisional application No. 63/686,572, filed on Aug. 23, 2024.

(51) Int. Cl. F16L 5/10; E04F 17/02; F23J 13/00; F24C 15/00

(52) U.S. Cl. CPC F16L 5/10; E04F 17/02; F23J 13/00; F24C 15/002

(57) ABSTRACT

A wall thimble alignment trim for a wall thimble, and a wall thimble having a wall thimble alignment trim is provided. The wall thimble alignment trim includes a body having an opening. The opening has a first profile portion and a second profile portion. The second profile portion has an opening area that is greater than an opening area of the first profile portion.

### CROSS REFERENCE TO RELATED APPLICATIONS

This Application claims the benefit of U.S. Provisional Application No. 63/686,572 filed Aug. 23, 2024, the disclosure of which is incorporated herein by reference in its entirety.

### FIELD OF THE INVENTION

Embodiments disclosed herein are directed to a wall thimble alignment trim for a chimney, and a wall thimble assembly having a wall thimble alignment trim.

### BACKGROUND

A chimney assembly, such as a residential chimney assembly, for example, for a wood burning stove, a pellet stove, or the like, may include a wall thimble where the chimney passes through a combustible wall of a building structure to protect the wall from overheating. A conventional wall thimble commonly includes a circular opening to accommodate a round chimney pipe and maintain a minimum air space clearance between the chimney pipe and a combustible material of the wall. For example, a conventional wall thimble may include an interior trim plate (e.g., a painted finishing plate) configured to be positioned on a first side of the wall and an exterior trim plate configured to be positioned on a second side of the wall and two cylinders (e.g., an interior cylinder and an exterior cylinder) disposed between the interior and exterior trim plates that telescopically adjust to fit a thickness of the wall. In other examples, a conventional wall thimble may include a single cylinder sized to fit a particular wall thickness.

### SUMMARY

The embodiments disclosed herein address problems associated with conventional wall thimbles. A conventional wall thimble commonly includes a circular opening to accommodate a round chimney pipe inserted through the wall thimble and to maintain a minimum air space clearance between the chimney pipe and a combustible material of the wall. Some conventional round chimney pipes may include one or more connecting features for coupling lengths of chimney pipe together such as one or more of a male and/or female end, a locking screw, a locking band, or another locking mechanism for securing chimney pipes together. The present embodiments recognize that, during installation of a chimney pipe into a wall thimble, the connecting features of the chimney pipe may not fit through the circular opening of the wall thimble when the chimney pipe is being fed through the wall thimble. As a result, an installer may need to carefully plan the installation so that a joint of the chimney pipe is not located inside the wall section or does not have to be inserted through the wall thimble, which may require time consuming planning. Moreover, in some cases, it may not be possible to avoid having to insert a chimney pipe with a joint section into the wall thimble even with extensive, and time-consuming planning. To attempt to solve these problems, a conventional wall thimble may be provided with a two-piece trim plate having an upper plate section with a U-shaped opening and a lower plate section with a corresponding U-shaped opening that can be positioned around the chimney pipe after the chimney pipe and the joint section have been inserted through the wall opening, thereby surrounding the chimney pipe and forming a circular opening of the wall thimble. The present embodiments recognize that, since the parts of the trim plate are not installed until after the chimney pipe is already inserted through the wall thimble, the conventional wall thimble will not support or position the chimney pipe during installation. As a result, an installer may need to provide temporary support of the chimney pipe during installation until the upper and lower plates are installed around the chimney pipe. This may lead to difficulty in positioning and aligning a centerline of the chimney pipe for installation with supplemental components of the chimney system and require an installer to take measurements and determine a temporary support position of the chimney pipe.

These problems, and others, are addressed by the embodiments as described herein, a first exemplary embodiment of which may comprise a wall thimble alignment trim for a wall thimble assembly that simplifies installation of a chimney pipe through the wall thimble.

An exemplary embodiment may comprise a wall thimble alignment trim for a wall thimble assembly, wherein the wall thimble alignment trim includes a body having an opening, wherein the opening includes a first profile portion and a second profile portion, wherein the second profile portion has an opening area that is greater than an opening area of the first profile portion.

In this way, the exemplary wall thimble assembly can allow a pipe (e.g., a chimney pipe or chimney pipe assembly), including one or more locking and/or connecting features for coupling lengths of chimney pipe (e.g., segment or length of chimney pipe) together, such as one or more of a male and/or female end, a locking screw, a locking band, or another locking mechanism or joint for securing segments of chimney pipes together, and/or another obstruction on the chimney pipe (or chimney pipe assembly), to simply and easily pass through the wall thimble without interference when the chimney pipe (or chimney pipe assembly) is being fed through the wall thimble assembly, thereby simplifying the installation process, minimizing or reducing installation time, and/or minimizing or reducing installation effort and planning. The exemplary wall thimble assembly can support the chimney pipe (or chimney pipe assembly) during installation, such as during insertion of one or more segments of pipe through a wall, thereby avoiding or minimizing a need for an installer to provide temporary support of the chimney pipe (or chimney pipe assembly) during installation. The exemplary wall thimble assembly can align and/or guide the chimney pipe (or chimney pipe assembly) during installation. Furthermore, the exemplary wall thimble assembly can position and align a centerline of the chimney pipe (or chimney pipe assembly) for installation with supplemental components of the chimney pipe assembly without requiring that an installer take extensive measurements to determine a position of the chimney pipe (or chimney pipe assembly) and/or other components. For example, the exemplary wall thimble assembly can minimize or avoid an installer having to take measurements to determine a mounting location of one or more components to be coupled to the chimney pipe (or chimney pipe assembly) or dependent on an alignment or position of the chimney pipe (or chimney pipe assembly). Moreover, the exemplary wall thimble assembly can provide strength and support to the chimney pipe (or chimney pipe assembly) during installation of the chimney pipe (or chimney pipe assembly) through a wall and/or after installation of the chimney pipe (or chimney pipe assembly) through a wall. For example, the exemplary wall thimble assembly can provide strength and support to position one or more additional pipe segments (or the chimney pipe assembly) and/or other components without having to take measurements to determine mounting locations. In some embodiments, one or more of a chimney pipe adapter, a chimney pipe, a tee assembly, a tee assembly support, and/or another pipe length can be preassembled and positioned without the need to take measurements and/or determine a mounting location. Furthermore, in some embodiments, a chimney pipe (or chimney pipe assembly) may be supported entirely from within the wall thimble alignment trim and/or wall thimble assembly.

An exemplary embodiment may comprise a wall thimble alignment trim for a wall thimble assembly, wherein the wall thimble alignment trim includes a body having an opening, wherein the opening includes a first profile portion and a second profile portion, wherein the second profile portion has an opening area that is greater than an opening area of the first profile portion. In some embodiments, the first profile portion is a lower profile portion and the second profile portion is an upper profile portion. In some embodiments, the first profile portion and the second profile portion form a mushroom shape. In some embodiments, the first profile portion has a curved profile having a first radius and the second profile portion has a curved profile having a second radius, wherein the second radius is greater than the first radius. In some embodiments, the first profile portion has a different profile shape than the second profile portion. In some embodiments, one or both of the first profile portion and the second profile portion has a constant radius profile. In some embodiments, one or both of the first profile portion and the second profile portion has a variable radius profile. In some embodiments, one or both of the first profile portion and the second profile portion has a profile shape other than a radial profile shape or a curved profile shape. In some embodiments, the opening includes a transitional section between the first profile portion and the second profile portion. In some embodiments, the body of a wall thimble alignment trim comprises a trim plate. In some embodiments, the wall thimble alignment trim includes an upper trim plate coupled to the body of the wall thimble alignment trim to cover or close off the second profile portion of the opening.

Another exemplary embodiment may comprise a wall thimble assembly including a wall thimble alignment trim.

In some embodiments, the wall thimble assembly includes one or more shields configured for a thickness of a wall, and a trim plate at first end of the one or more shields, wherein the wall thimble alignment trim is at a second end of the one or more shields. In some embodiments, the wall thimble assembly includes a first shield and a second shield, wherein the first shield and the second shield are telescopically adjustable with respect to each other. In some embodiments, the wall thimble assembly includes a trim plate at first end of the first shield, wherein the wall thimble alignment trim is at a second end of the second shield, the second end being opposite the first end of the first shield.

Another exemplary embodiment may comprise a wall thimble assembly comprising a wall thimble alignment trim, wherein the wall thimble assembly includes one or more shields configured for a thickness of a wall; a trim plate at first end of the one or more shields, wherein the wall thimble alignment trim is at a second end of the one or more shields; and one or more pipes, wherein a part of the one or more pipes extends through the opening of the wall thimble alignment trim. In some embodiments, a part of the one or more pipes extends through the one or more shields. In some embodiments, the one or more shields comprises a first shield and a second shield, wherein the first shield and the second shield are telescopically adjustable with respect to each other. In some embodiments, the wall thimble assembly comprises a trim plate at first end of the first shield, wherein the wall thimble alignment trim is at a second end of the second shield, the second end being opposite the first end of the first shield. In some embodiments, the one or more pipes includes one or more chimney pipes. In some embodiments, the one or more pipes includes a first pipe coupled to a second pipe by one or more locking means. In some embodiments, the locking means include one or more locking bands. In some embodiments, the locking means include one or more screws. In some embodiments, the wall thimble assembly includes a tee assembly coupled to an end of the one or more chimney pipes or chimney pipe assemblies. In some embodiments, the wall thimble assembly includes a tee assembly support coupled to an end of the tee assembly. In some embodiments, the wall thimble assembly includes a pipe length coupled to an end of the tee assembly support.

Another exemplary embodiment may comprise a method of installing a wall thimble assembly comprising a wall thimble alignment trim. In some embodiments, the method may include installing one or more other components, such as a tee assembly, a tee assembly support, and/or one or more pipe lengths.

Other features and advantages of the present invention will become apparent to those skilled in the art upon review of the following detailed description and drawings.

### BRIEF DESCRIPTION OF THE DRAWINGS

These and other aspects and features of embodiments of the present invention will be understood by the skilled artisan after a reading of the following detailed description, together with the attached drawings, wherein:

FIG. 1 depicts an exploded perspective view of a wall thimble assembly having a wall thimble alignment trim, according to one or more exemplary embodiments of the disclosure.

FIG. 2 depicts a front view of a wall thimble alignment trim, according to one or more exemplary embodiments of the disclosure.

FIG. 3 depicts a side view of a chimney pipe assembly, according to one or more exemplary embodiments of the disclosure.

FIG. 4 depicts an end view of a chimney pipe assembly, according to one or more exemplary embodiments of the disclosure.

FIG. 5 depicts steps of assembling a chimney pipe assembly, according to one or more exemplary embodiments of the disclosure.

FIG. 6 depicts an end view of a chimney pipe assembly while being inserted in a wall thimble assembly having a wall thimble alignment trim, according to one or more exemplary embodiments of the disclosure.

FIG. 7 depicts an end view of a chimney pipe assembly after being inserted in a wall thimble assembly having a wall thimble alignment trim, according to one or more exemplary embodiments of the disclosure.

FIG. 8 depicts an exploded perspective view of a wall assembly including a wall thimble assembly having a wall thimble alignment trim, a chimney pipe adapter, a chimney pipe assembly, a tee assembly, a tee assembly support, and another pipe length, according to one or more exemplary embodiments of the disclosure.

FIG. 9 depicts an exploded perspective view of a wall thimble assembly having a wall thimble alignment trim with an assembled chimney pipe adapter, chimney pipe assembly, and tee assembly, according to one or more exemplary embodiments of the disclosure.

FIG. 10 depicts a perspective view of an assembled chimney pipe adapter, chimney pipe assembly, and tee assembly being inserted into a wall thimble assembly having a wall thimble alignment trim, according to one or more exemplary embodiments of the disclosure.

FIG. 11 depicts a perspective view of an assembled chimney pipe adapter, chimney pipe assembly, and tee assembly after being inserted into a wall thimble assembly having a wall thimble alignment trim, according to one or more exemplary embodiments of the disclosure.

FIG. 12 depicts a perspective view of an assembled chimney piper adapter, chimney pipe assembly, and tee assembly after being inserted into a wall thimble assembly having a wall thimble alignment trim and providing an upper trim plate, according to one or more exemplary embodiments of the disclosure.

FIG. 13 depicts a side view of an assembled wall assembly including a wall thimble assembly having a wall thimble alignment trim, a chimney pipe adapter, a chimney pipe assembly, a tee assembly, a tee assembly support, and another pipe length, according to one or more exemplary embodiments of the disclosure.

FIG. 14 depicts a side view of an assembled wall assembly including a wall thimble assembly having a wall thimble alignment trim, a chimney pipe adapter, a chimney pipe assembly, a tee assembly, a tee assembly support, and another pipe length, according to one or more exemplary embodiments of the disclosure.

FIG. 15 depicts a perspective view of a wall having a rough-in opening for receiving a wall thimble assembly and a chimney pipe assembly, according to one or more exemplary embodiments of the disclosure.

FIG. 16 depicts a perspective view of a wall thimble alignment trim installed over the rough-in opening of the wall of FIG. 15, according to one or more exemplary embodiments of the disclosure.

FIG. 17 depicts a perspective view of an assembled chimney pipe assembly, tee assembly, and tee assembly support installed in the wall thimble alignment trim of FIG. 16, according to one or more exemplary embodiments of the disclosure.

FIG. 18 depicts a perspective view of an assembled chimney pipe assembly, tee assembly, and tee assembly installed in a wall thimble alignment trim, as depicted in FIG. 17, with an upper time plate installed on the wall thimble alignment trim, according to one or more exemplary embodiments of the disclosure.

### DETAILED DESCRIPTION

Embodiments of the present disclosure are described more fully hereinafter with reference to the accompanying drawings. The embodiments disclosed herein may encompass many different forms and should not be construed as limited to the embodiments set forth herein; rather, these embodiments are provided so that this disclosure will be thorough and complete, and will fully convey the scope of the invention to those skilled in the art.

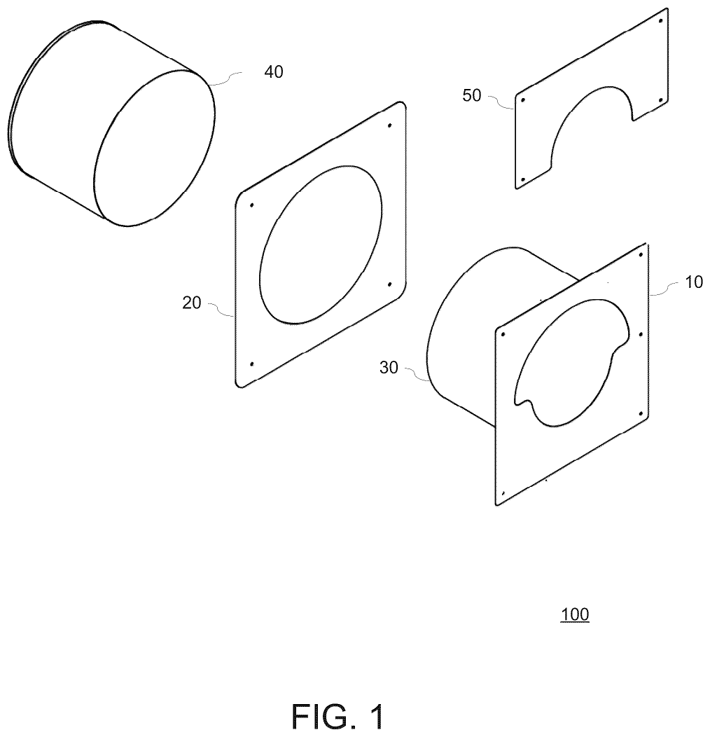

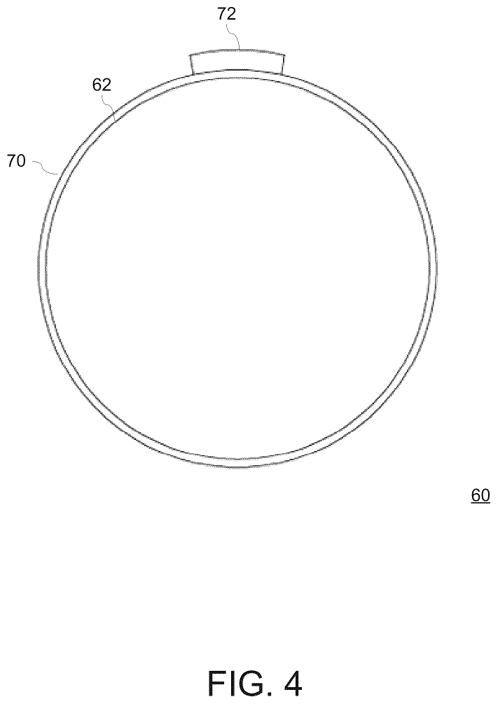

Referring now to the drawings, FIGS. 1-18 depict exemplary embodiments of a wall thimble having a wall thimble alignment trim, a wall thimble alignment trim, a chimney pipe assembly, and a wall assembly, as described herein.

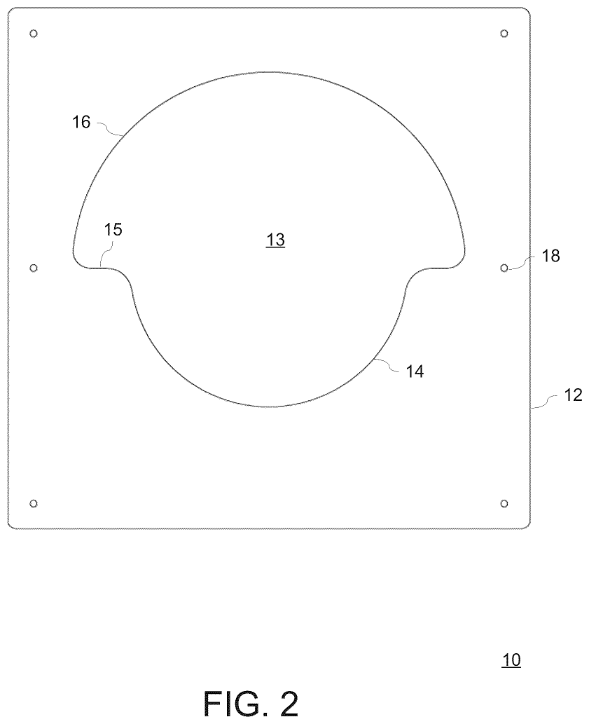

With reference to the drawings, FIG. 1 and FIG. 2 depict exemplary embodiments of a wall thimble assembly 100 having a wall thimble alignment trim 10, as described herein. As shown in FIG. 1, an exemplary wall thimble assembly 100 may comprise a wall thimble alignment trim 10, a second trim 20, a first shield 30, a second shield 40, and an upper trim plate 50. One of ordinary skill in the art will recognize that other wall thimble arrangements and components are contemplated by the invention.

As shown in FIG. 2, an exemplary wall thimble alignment trim 10 may comprise a trim plate 12 having an opening 13. In some embodiments, a trim plate 12, as described herein, may comprise a square shape, as depicted in FIG. 2. In some embodiments, a trim plate 12, as described herein, may comprise a non-square shape, such as, for example, a round shape.

In some embodiments, an opening 13, as described herein, may comprise a first profile portion 14 (e.g., lower profile portion) and a second profile portion 16 (e.g., upper profile portion). In some embodiments, a second profile portion 16, as described herein, may define an opening area that is greater than an opening area defined by a first profile portion 14, as described herein. That is, a second profile portion 16, as described herein, may define an oversized opening compared to an opening defined by a first profile portion 14, as described herein. In some embodiments, a first profile portion 14, as described herein, may comprise a curved profile having a first radius and a second profile portion 16, as described herein, may comprise a curved profile having a second radius, wherein the second radius is greater than the first radius. In some embodiments, the first radius of the first profile portion 14, as described herein, can correspond to a pipe radius of a chimney pipe (described in more detail below). In some embodiments, the second radius of the second profile portion 16, as described herein, may be greater than an outermost radius of a chimney pipe assembly, wherein the chimney pipe assembly may include, for example, one or more locking bands and/or one or more tightening assemblies (described in more detail below).

In some embodiments, an opening 13, as described herein, may comprise a transitional section 15 provided between, and adjoining, a first profile portion 14, as described herein, and a second profile portion 16, as described herein. A transitional section 15, as described herein, is not limited to any shape or profile. In some embodiments, a transitional section 15, as described herein, may define a segment that is orthogonal or normal to a portion or curve of the first profile portion 14 and/or the second profile portion 16. In some embodiments, all or a segment of a transitional section 15, as described herein, may extend at an angle to a portion of the first profile portion 14 and/or the second profile portion 16.

As shown in FIG. 2, an opening 13, as described herein, may define a mushroom shaped opening formed by a transitional section 15 provided between, and adjoining, a first profile portion 14, as described herein, and a second profile portion 16, as described herein. In the foregoing embodiment, the first profile portion 14 comprises a curved profile having a first radius and the second profile portion 16 comprises a curved profile having a second radius, wherein the second radius is greater than the first radius. As a consequence, the second profile portion 16 defines an oversized opening compared to the opening defined by the first profile portion 14. In the foregoing embodiment, the first radius of the first profile portion 14 may correspond to a pipe radius of a chimney pipe (described in more detail below). In the foregoing embodiment, the second radius of the second profile portion 16 may be greater than an outermost radius of a chimney pipe assembly, wherein the chimney pipe assembly may include, for example, one or more locking bands and/or one or more tightening assemblies (described in more detail below).

In some embodiments an opening 13, as described herein, may define a lightbulb shaped opening formed by a transitional section 15 provided between, and adjoining, a first profile portion 14, as described herein, and a second profile portion 16, as described herein. In the foregoing embodiment, the first profile portion 14 comprises a curved profile having a first radius and the second profile portion 16 comprises a curved profile having a second radius, wherein the second radius is greater than the first radius. As a consequence, the second profile portion 16 defines an oversized opening compared to the opening defined by the first profile portion 14. In the foregoing embodiment, the first radius of the first profile portion 14 may correspond to a pipe radius of a chimney pipe (described in more detail below). In the foregoing embodiment, the second radius of the second profile portion 16 may be greater than an outermost radius of a chimney pipe assembly, wherein the chimney pipe assembly may include, for example, one or more locking bands and/or one or more tightening assemblies (described in more detail below).

In some embodiments an opening 13, as described herein, may define a pill shaped opening formed by a transitional section 15 provided between, and adjoining, a first profile portion 14, as described herein, and a second profile portion 16, as described herein. In the foregoing embodiment, the first profile portion 14 comprises a curved profile having a first radius and a first radial center and the second profile portion 16 comprises a curved profile having a second radius and a second radial center, wherein the second radius is equal to the first radius, the first radial center and the second radial center are non-colocalized, and the transitional section 15 extends linearly between the first profile portion 14 and the second profile portion 16. As a consequence, the second profile portion 16 defines an opening that is equal in size to the opening defined by the first profile portion 14. In the foregoing embodiment, the first radius of the first profile portion 14 may correspond to a pipe radius of a chimney pipe (described in more detail below). In the foregoing embodiment, the second radius of the second profile portion 16 may be centered about a location that permits an outermost radius of a chimney pipe assembly to fit within the opening defined by the second profile portion 16, wherein the chimney pipe assembly may include, for example, one or more locking bands and/or one or more tightening assemblies (described in more detail below).

In some embodiments an opening 13, as described herein, may define an opening formed by a transitional section 15 provided between, and adjoining, a first profile portion 14, as described herein, and a second profile portion 16, as described herein. In the foregoing embodiment, the first profile portion 14 comprises a curved profile having a first radius and a first radial center and the second profile portion 16 comprises a curved profile having a second radius and a second radial center, wherein the second radius is equal to the first radius, the first radial center and the second radial center are non-colocalized, and the transitional section 15, or a segment thereof, comprises a curved profile and extends between the first profile portion 14 and the second profile portion 16. As a consequence, the second profile portion 16 defines an opening that is equal in size to the opening defined by the first profile portion 14. In the foregoing embodiment, the first radius of the first profile portion 14 may correspond to a pipe radius of a chimney pipe (described in more detail below). In the foregoing embodiment, the second radius of the second profile portion 16 may be centered about a location that permits an outermost radius of a chimney pipe assembly to fit within the opening defined by the second profile portion 16, wherein the chimney pipe assembly may include, for example, one or more locking bands and/or one or more tightening assemblies (described in more detail below).

In some embodiments an opening 13, as described herein, may define an opening formed by a transitional section 15 provided between, and adjoining, a first profile portion 14, as described herein, and a second profile portion 16, as described herein. In the foregoing embodiment, the first profile portion 14 comprises a curved profile having a first radius and a first radial center and the second profile portion 16 comprises a curved profile having a second radius and a second radial center, wherein the second radius is equal to the first radius, the first radial center and the second radial center are non-colocalized, and the transitional section 15, or a segment thereof, comprises: (i) a linear profile on both sides of the transitional section 15; (ii) a linear profile on one side of the transitional section 15 and a curved profile on the other side of the transitional section 15; or (iii) a curved profile on both sides of the transitional section 15; and extends between the first profile portion 14 and the second profile portion 16. As a consequence, the second profile portion 16 defines an opening that is equal in size to the opening defined by the first profile portion 14. In the foregoing embodiment, the first radius of the first profile portion 14 may correspond to a pipe radius of a chimney pipe (described in more detail below). In the foregoing embodiment, the second radius of the second profile portion 16 may be centered about a location that permits an outermost radius of a chimney pipe assembly to fit within the opening defined by the second profile portion 16, wherein the chimney pipe assembly may include, for example, one or more locking bands and/or one or more tightening assemblies (described in more detail below).

As described herein, a first profile portion 14 and a second profile portion 16 are not limited to the illustrated examples and may comprise other profile shapes, sizes, and arrangements. In some embodiments, a second profile portion 16, as described herein, may comprise a corresponding or similar profile shape as a first profile portion 14, as described herein. As one non-limiting example, a first profile portion 14, as described herein, and a second profile portion 16, as described herein, may each comprise a constant radius profile, such as a portion of a circle. In some embodiments, a first profile portion 14, as described herein, and a second profile portion 16, as described herein, may each comprise a variable radius profile. As one non-limiting example, a first profile portion 14, as described herein, and a second profile portion 16, as described herein, may each comprise a variable radius profile, such as a portion of an oval, an ellipse, or any other curved shape. In some embodiments, a first profile portion 14, as described herein, and a second profile portion 16, as described herein, may each comprise a profile shape other than a constant radius profile or a variable radius profile shape, as described herein. As one non-limiting example, a first profile portion 14, as described herein, and a second profile portion 16, as described herein, may each comprise a profile that is formed by a portion of a square shape, a triangular shape, a hexagonal shape, or any other shape capable of supporting a chimney pipe and permitting a chimney pipe assembly to pass therethrough (described in more detail below).

In some embodiments, a second profile portion 16, as described herein, may comprise a profile shape that is different than a profile shape of a first profile portion 14, as described herein. For example, a first profile portion 14, as described herein, may comprise a profile shape corresponding to a part of a circle having a first radius, such as a first radius corresponding to or substantially equal to a pipe radius of a chimney pipe, whereas, a second profile portion 16, as described herein, may comprise a different profile shape, such as a portion of an oval shape, a square shape, a hexagonal shape, or another shape capable of permitting a chimney pipe assembly to pass through the combined opening area of the first profile portion 14 and the second profile portion 16.

In some embodiments, a wall thimble alignment trim 10 may comprise one or more penetrations and/or fixation points 18 configured to secure the wall thimble alignment trim 10 to a wall.

In some embodiments, a wall thimble alignment trim 10, as described herein, may comprise a first shield 30 and a second shield 40 comprising two cylinders (e.g., an interior cylinder 30 and an exterior cylinder 40) disposed between the wall thimble alignment trim 10 and a second trim 20 (e.g., interior and exterior trim plates) that telescopically adjust to fit a thickness of a wall. In some embodiments, a first shield 30 and a second shield 40, as described herein, can be sized to fit a particular wall thickness. In some embodiments, a first shield 30 and/or a second shield 40, as described herein, may comprise insulation materials or layers. In some embodiments, a first shield 30 and/or a second shield 40, as described herein, may comprise additional shielding materials or layers.

In some embodiments, a wall thimble alignment trim 10, as described herein, may comprise an upper trim plate 50 configured to be coupled to a surface of the wall thimble alignment trim 10 to cover or close off a second profile portion 16 of an opening 13, as described herein. In some embodiments, an upper trim plate 50, as described herein, may comprise a third profile portion configured to cooperate with the first profile portion 14 of a wall thimble alignment trim 10, as described herein, to surround a chimney pipe 62, as described herein. In some embodiments, a third profile portion of the upper trim plate 50, as described herein, may comprise a profile shape corresponding to a part of a circle having a first radius, such as a first radius corresponding to or substantially equal to a pipe radius of a chimney pipe 62, as described herein. In some embodiments, an upper trim plate 50, as described herein, can cooperate with the first profile portion 14 of a wall thimble alignment trim 10, as described herein, to form a circular opening surrounding a chimney pipe 62, as described herein.

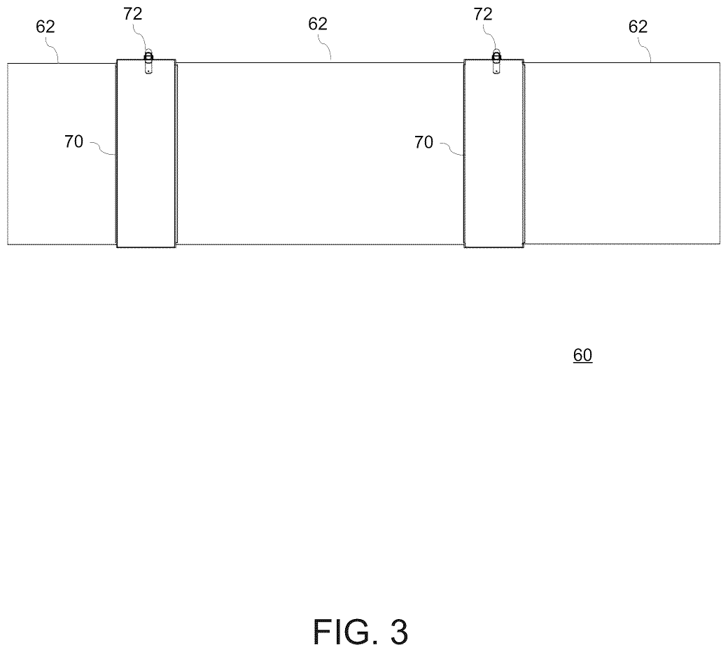

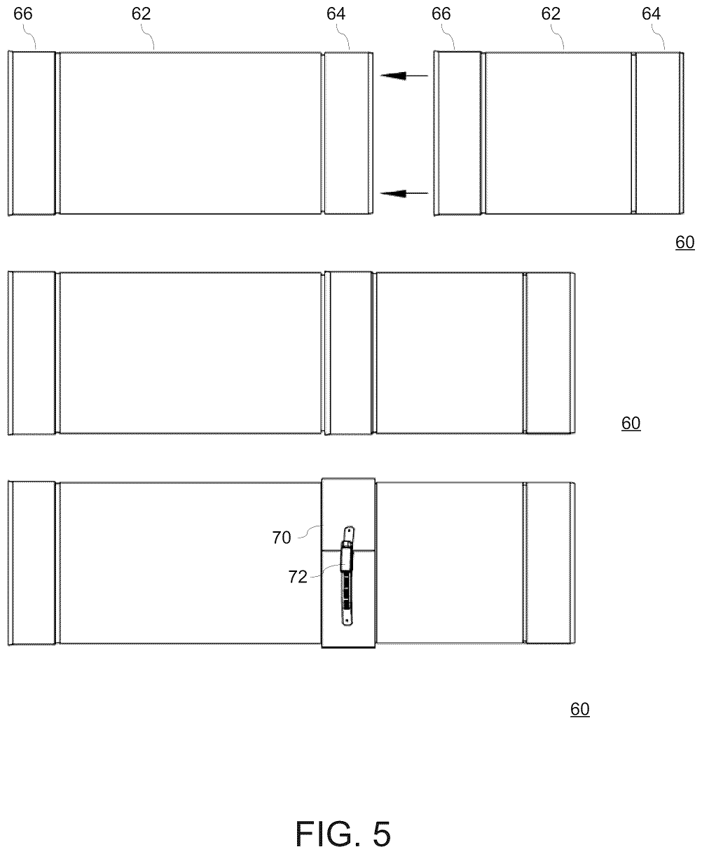

With reference to the drawings, FIGS. 3-5 depict examples of a chimney pipe assembly 60. As shown in FIGS. 3-5, a chimney pipe assembly 60, as described herein, may comprise at least one chimney pipe 62 (e.g., pipe length) or section thereof. As shown in FIGS. 3-5, a chimney pipe 62, as described herein, may be a round chimney pipe comprising a cross-section with a circular shape, however, a chimney pipe may comprise a cross-section with a different shape, and such cross-sections are possible and contemplated within the spirit and scope of the invention. In some embodiments, two or more chimney pipes 62 may be coupled together. As shown in FIG. 3 and FIG. 5, chimney pipes 62, as described herein, may be coupled together by one or more locking bands 70. In some embodiments, locking bands 70, as described herein, may comprise an adjustable locking band having a tightening assembly 72 (e.g., a captured nut and screw tightening assembly (as shown in FIGS. 3-5), a screw drive, and the like). In some embodiments, locking bands 70, as described herein, may comprise one or more flanges extending radially from the band and coupled together, for example, by one or more screws. As shown in FIG. 5, one or more chimney pipes 62, as described herein, may comprise a male end 64 and a female end 66 configured to be coupled together. As shown in FIG. 5, an interlocking male end 64 and a female end 66 may be secured together by one or more locking bands 70, as described herein. One of ordinary skill in the art will recognize that other chimney pipe arrangements and components are contemplated by the invention.

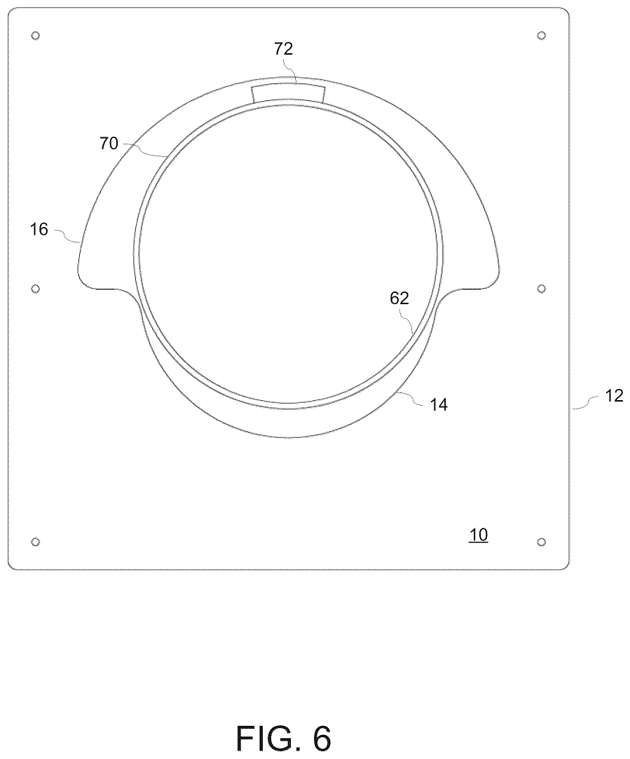

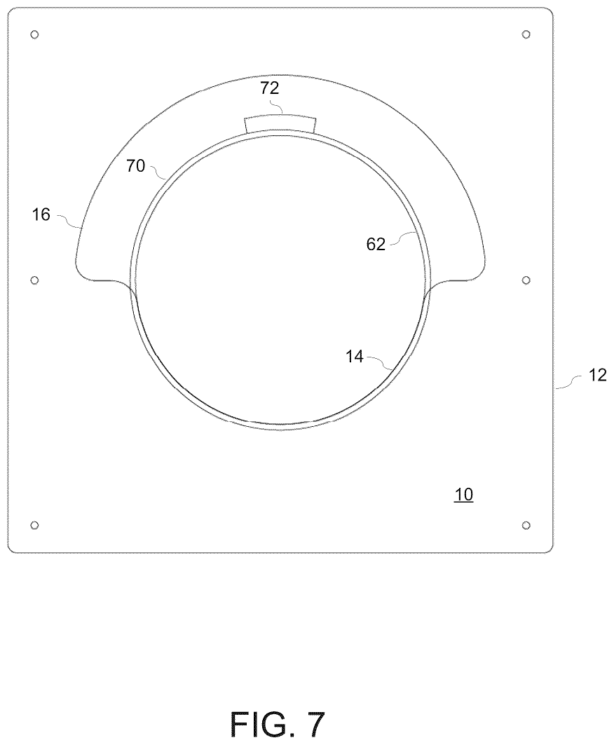

With reference to the drawings, FIG. 6 and FIG. 7, depict exemplary steps of installing a chimney pipe assembly 60, as described herein, a wall thimble alignment trim 10, as described herein. With reference to FIG. 6 and FIG. 7, the wall thimble alignment trim 10 may be part of a wall thimble assembly 100, as described herein. As shown in FIG. 6, a chimney pipe assembly 60, as described herein, may be inserted into the opening 13 of a wall thimble alignment trim 10, as described herein, wherein the arrangement of the first profile 14 and the second profile 16 can provide sufficient clearance to permit the chimney pipe assembly 60, including one or more locking bands 70and tightening assemblies 72, flanges, screws, or one or more other parts or other obstructions associated with the chimney pipe assembly 60, to pass through the opening 13 without interference.

As shown in FIG. 7, after a portion of a chimney pipe assembly 60, as described herein, which has an obstruction (such as one or more locking bands 70 and tightening assemblies 72) is passed through the opening 13 of a wall thimble alignment trim 10, as described herein, a part of the chimney pipe assembly 60 (i.e., a chimney pipe 62) can be lowered into and fit in the first profile 14 of the opening 13 of the wall thimble alignment trim 10. In the foregoing embodiment, the first profile portion 14 may comprise a profile shape corresponding to or substantially equal to a pipe radius of the chimney pipe 62 that is lowered into the first profile 14; as a consequence, the first profile portion 14 can secure and align a position of the chimney pipe 62. In some embodiments, a first profile portion 14, as described herein, can center a chimney pipe 62, as described herein, in a desired position and stabilize the chimney pipe assembly 60 within the opening 13 of a wall thimble alignment trim 10, as described herein, such that supports and/or other supplemental components can be secured in place (e.g., without having to temporarily support and/or stabilize the chimney pipe assembly 60). In some embodiments, a chimney pipe assembly 60, as described herein, may be supported entirely by, or from within, a wall thimble alignment trim 10, as described herein. In some embodiments, a first profile portion 14, as described herein, may be configured to establish the correct placement of one or more supplemental components. As described herein, supplemental components or other parts may comprise, for example, one or more other chimney pipe lengths, tee assemblies, and/or support brackets. Accordingly, a first profile portion 14, as described herein, permits one or more supplemental components or other parts (e.g., other chimney pipe lengths, tee assemblies, and/or support brackets) to be preassembled and positioned in place and a chimney pipe 62, as described herein, can be aligned with the one or more supplemental components or other parts by the first profile portion 14. In some embodiments, one or more supplemental components or other parts, as described herein, may be preassembled and positioned in place without a need to take measurements and/or determine mounting location based on a location of a chimney pipe 62, as described herein, since a first profile portion 14, as described herein, establishes the placement and/or centering of the chimney pipe 62.

In some embodiments, a wall thimble alignment trim 10, as described herein, may permit a chimney pipe 62, as described herein, and/or chimney pipe assembly 60, as described herein, which may include one or more locking bands 70, tightening assemblies 72, flanges, screws, or one or more other parts or other obstructions associated with the chimney pipe assembly 60, to pass through the opening 13 of the wall thimble alignment trim 10 without interference when the chimney pipe 62 is being fed through the wall thimble alignment trim 10, thereby simplifying the installation process, minimizing or reducing installation time, and/or minimizing or reducing installation effort and planning. For example, the arrangement of the first profile 14 and/or the second profile 16 can allow the chimney pipe 62, chimney pipe assembly 60, locking bands 70, tightening assemblies 72, flanges, screws, and/or one or more other parts or other obstructions associated with the chimney pipe assembly 60 to pass through the opening 13 without interference. In some embodiments, at least a part of the second profile 16 (e.g., forming at least a part the opening 13) can allow the chimney pipe 62, chimney pipe assembly 60, locking bands 70, tightening assemblies 72, flanges, screws, and/or one or more other parts or other obstructions associated with the chimney pipe assembly 60 to pass through the opening 13 of the wall thimble alignment trim 10 without interference.

In some embodiments, a wall thimble alignment trim 10, as described herein, may support a chimney pipe 62 and/or a chimney pipe assembly 60, as described herein, during installation, such as during insertion of one or more segments of the chimney pipe 62 and/or the chimney pipe assembly 60 through a wall W, thereby avoiding or minimizing a need for an installer to provide temporary support of the chimney pipe 62 and/or the chimney pipe assembly 60 during installation. A wall thimble alignment trim 10, as described herein, may align and/or guide a chimney pipe 62 and/or a chimney pipe assembly 60, as described herein, during installation. For example, the arrangement of the first profile 14 and/or the second profile 16 can support, guide, and/or align the chimney pipe 62 and/or chimney pipe assembly 60 as it passes through the opening 13 of the wall thimble alignment trim 10. In some embodiments, at least a part of a surface (e.g., a part or all of a surface of a profile edge) of a first profile 14, as described herein, can support, guide, and/or align a chimney pipe 62 and/or a chimney pipe assembly 60, as described herein, as it passes through the opening 13 of the wall thimble alignment trim 10.

In some embodiments, a wall thimble alignment trim 10, as described herein, can position and align a centerline of a chimney pipe 62 and/or a chimney pipe assembly 60, as described herein, for installation with supplemental components of a chimney system without requiring an installer to take extensive measurements to determine a position of supplemental components or other parts, as described herein. For example, the wall thimble alignment trim 10 can minimize or avoid an installer having to take measurements to determine a mounting location of one or more components to be coupled to the chimney pipe 62 and/or chimney pipe assembly 60 or that are dependent on an alignment and/or position (e.g., a fixed and/or installed alignment and/or position) of the chimney pipe 62 and/or chimney pipe assembly 60. In some embodiments, a wall thimble alignment trim 10, as described herein, can provide strength and support to a chimney pipe 62 and/or a chimney pipe assembly 60, as described herein, during installation of the chimney pipe 62 and/or chimney pipe assembly 60 through a wall W and/or after installation of the chimney pipe 62 and/or chimney pipe assembly 60 through the wall W. For example, the wall thimble alignment trim 10 can provide strength and support to position one or more additional chimney pipes 62 and/or other components, as described herein, without having to take measurements to determine mounting locations for the same. In some embodiments, one or more of a chimney pipe adapter, a chimney pipe, a tee assembly, a tee assembly support, and/or a pipe length can be preassembled and positioned without the need to take measurements and/or determine a mounting location. In some embodiments, a chimney pipe 62 and/or a chimney pipe assembly 60, as described herein, may be supported entirely from within a wall thimble alignment trim 10 and/or wall thimble assembly 100, as described herein, (e.g., by the opening 13 or by at least a portion of one or more of the first profile 14 and/or the second profile 16 of the opening 13).

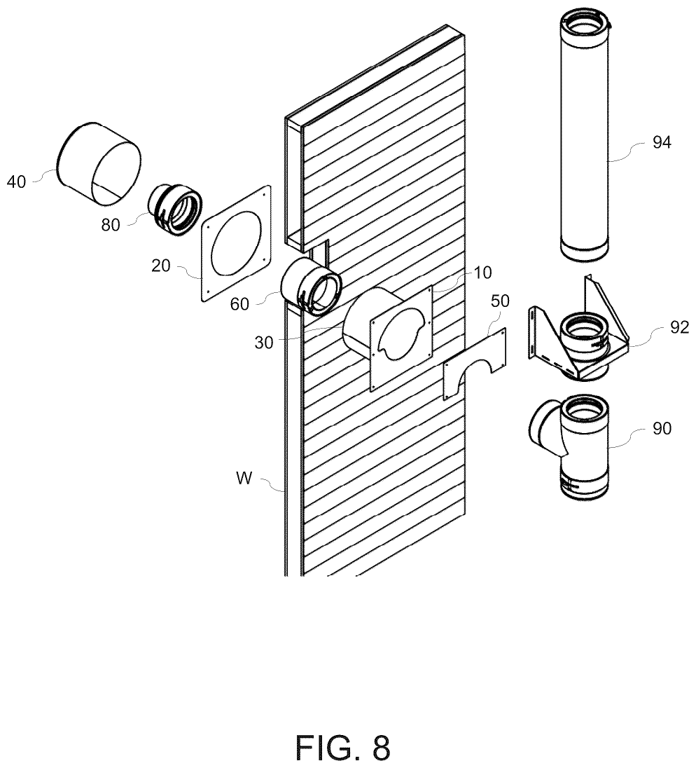

With reference to drawings, FIGS. 8-12 depict an exemplary wall assembly including a wall thimble assembly 100, as described herein, comprising a wall thimble alignment trim 10, as described herein. As shown in FIG. 8, a wall assembly, as described herein, may comprise a wall thimble 100 having a wall thimble alignment trim 10, a second trim 20, a first shield 30, a second shield 40, and an upper trim plate 50 to be installed in a penetration through a wall W. A chimney pipe assembly 60, as described herein, (e.g., a round chimney pipe assembly) can be inserted through the wall thimble assembly 100 to penetrate through the wall W while maintaining a minimum air space clearance between the chimney pipe 62 and related components and a combustible material of the wall W. As shown in FIG. 8, a wall assembly may comprise one or more of a tee assembly 90, a tee assembly support 92, and/or another pipe length 94. In some embodiments, a wall assembly, as described herein, may comprise a chimney pipe adapter 80 on an end of the chimney pipe assembly 60. In some embodiments, one or more locking bands and/or tightening assemblies, as described herein, and the like can be provided to couple and secure one or more of the components described herein together. As one non-limiting example, one or more locking bands, tightening assemblies, or the like may be provided to couple and secure a chimney pipe together with a chimney pipe assembly, another chimney pipe, a chimney pipe adapter, a tee assembly, a tee assembly support, another pipe length, or any combination of the foregoing. As another non-limiting example, one or more locking bands, tightening assemblies, or the like may be provided to couple and secure a chimney pipe assembly together with another chimney pipe assembly, a chimney pipe, a chimney pipe adapter, a tee assembly, a tee assembly support, another pipe length, or any combination of the foregoing. As another non-limiting example, one or more locking bands, tightening assemblies, or the like may be provided to couple and secure a tee assembly together with a chimney pipe assembly, a chimney pipe, a chimney pipe adapter, another tee assembly, a tee assembly support, another pipe length, or any combination of the foregoing. As another non-limiting example, one or more locking bands, tightening assemblies, or the like may be provided to couple and secure another pipe length together with a chimney pipe assembly, a chimney pipe, a chimney pipe adapter, a tee assembly, a tee assembly support, another pipe length, or any combination of the foregoing.

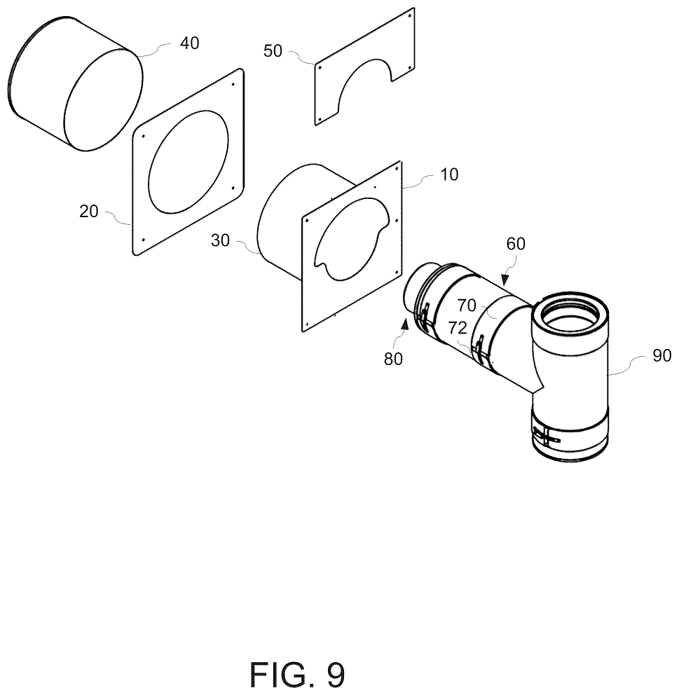

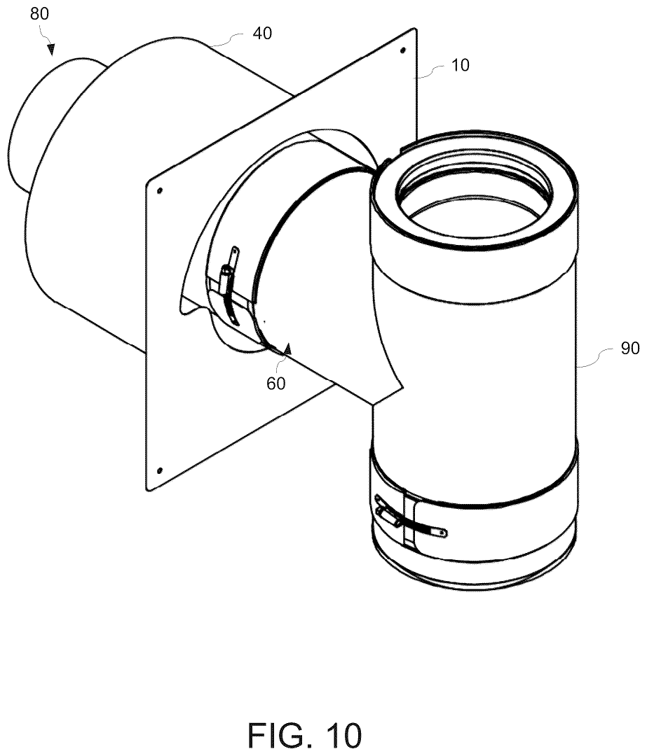

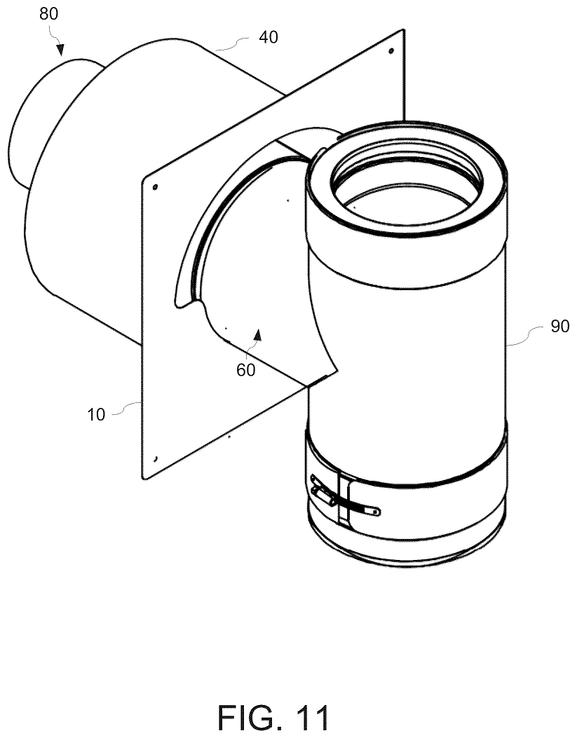

As shown in FIGS. 9-11, a chimney pipe adapter 80, a chimney pipe assembly 60, and a tee assembly 90, including one or more locking bands 70 and tightening assemblies 72, can be preassembled (FIG. 9) and a part of the resulting assembly can be inserted into an opening 13 of a wall thimble alignment trim 10 (FIG. 10). As shown in FIGS. 9-11, an arrangement of the first profile 14 and the second profile 16 of the wall thimble alignment trim 10 can provide sufficient clearance to permit the chimney pipe adapter 80 and a part of the chimney pipe assembly 60, including one or more locking bands 70 and tightening assemblies 72, to pass through the opening 13 without interference such that the chimney pipe adapter 80 and a part of the chimney pipe assembly 60 can extend through the first shield 30 and the second shield 40. As shown in FIG. 11, after a portion of the chimney pipe assembly 60 which has an obstruction is passed through the opening 13 of the wall thimble alignment trim 10, the chimney pipe assembly 60 can be lowered into and fit in the first profile 14 of the opening 13 of the wall thimble alignment trim 10. As shown in FIG. 11, the first profile portion 14 of the opening 13 of the wall thimble alignment trim 10 may comprise a profile shape that corresponds to or is substantially equal to a radius of a chimney pipe of the chimney pipe assembly 60. As a consequence, the first profile portion 14 can secure and align a position of the chimney pipe of the chimney pipe assembly 60. In some embodiments, after a portion of a chimney pipe assembly 60 which has an obstruction is passed through the opening 13 of the wall thimble alignment trim 10, as described herein, a tee assembly 90, as described herein, can be lowered into and fit in the first profile 14 of the opening 13 of the wall thimble alignment trim 10. In some embodiments, a first profile portion 14 of the opening 13 of the wall thimble alignment trim 10 may comprise a profile shape that corresponds to or is substantially equal to a radius of a tee assembly 90, as described herein. As a consequence, the first profile portion 14 can secure and align a position of the tee assembly 90. In some embodiments, a first profile portion 14, as described herein, can center a length of a chimney pipe 62, a length of a chimney pipe assembly 60, and/or a length of a of a tee assembly 90, as described herein, in a desired position and stabilize the chimney pipe 62, chimney pipe assembly 60, and/or the tee assembly 90 without temporary supports. In some embodiments, a first profile portion 14, as described herein, can establish the correct placement and alignment of a chimney pipe 62, a chimney pipe assembly 60, and/or a tee assembly 90, as described herein, with one or more supplemental components, such as a tee assembly support 92 and/or another pipe length 94. In some embodiments, one or more supplemental components (e.g., a tee assembly 90, a tee assembly support 92 and/or another pipe length 94) or other parts, as described herein, can be preassembled and positioned in place without the need to take measurements and/or determine mounting location since the first profile portion 14 establishes the placement and/or centering of the chimney pipe 62 or chimney pipe assembly 60 to which those supplemental components and/or other parts are connected.

In some embodiments, one or more of a chimney pipe adapter 80, a chimney pipe 62, a chimney pipe assembly 60, a tee assembly 90, a tee assembly support 92, and/or another pipe length 94, including one or more locking bands 70, as described herein, can be preassembled and part of the chimney pipe adapter 80, the chimney pipe 62, the chimney pipe assembly 60, and/or the tee assembly 90, can be inserted into an opening 13 of a the wall thimble alignment trim 10, as described herein. In this way, the chimney pipe adapter 80, the chimney pipe 62, the chimney pipe assembly 60, the tee assembly 90, the tee assembly support 92, and/or the another pipe length 94 can be preassembled and positioned without the need to take measurements and/or determine a mounting location.

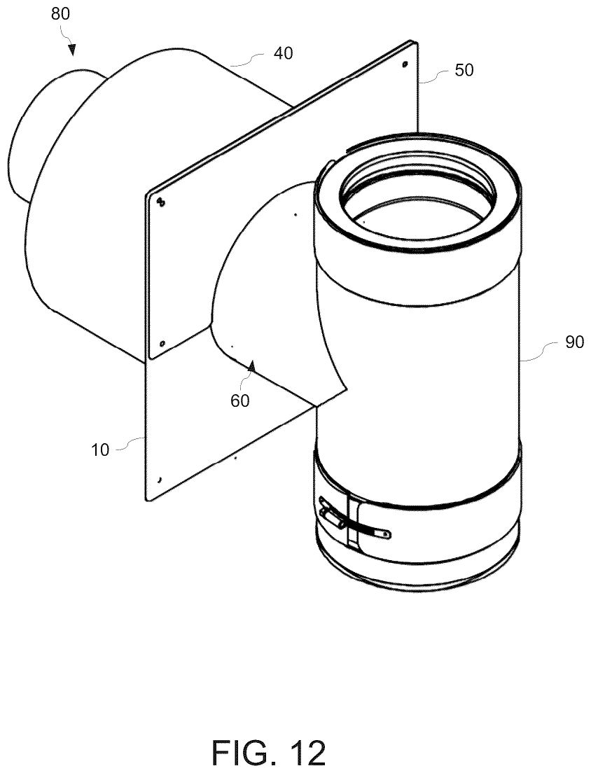

As shown in FIG. 12, an exemplary wall thimble alignment trim 10, as described herein, may comprise an upper trim plate 50 configured to be coupled to a surface of the wall thimble alignment trim 10 to cover or close off the second profile portion 16 of the opening 13 of the wall thimble alignment trim 10. In some embodiments, an upper trim plate 50, as described herein, may comprise a third profile portion configured to cooperate with the first profile portion 14 of the wall thimble alignment trim 10 to surround a chimney pipe 62, a chimney pipe assembly 60, or a tee assembly 90, as described herein. As shown in FIG. 12, a third profile portion of the upper trim plate 50, as described herein, may comprise a profile shape corresponding to a part of a circle having a first radius, such as a first radius corresponding to or substantially equal to a pipe radius of a chimney pipe of a chimney pipe assembly 60. In some embodiments, an upper trim plate 50, as described herein, can cooperate with the first profile portion 14 of the wall thimble alignment trim 10, as described herein, to form a circular opening surrounding a chimney pipe 62, a chimney pipe assembly 60, or a tee assembly 90, as described herein.

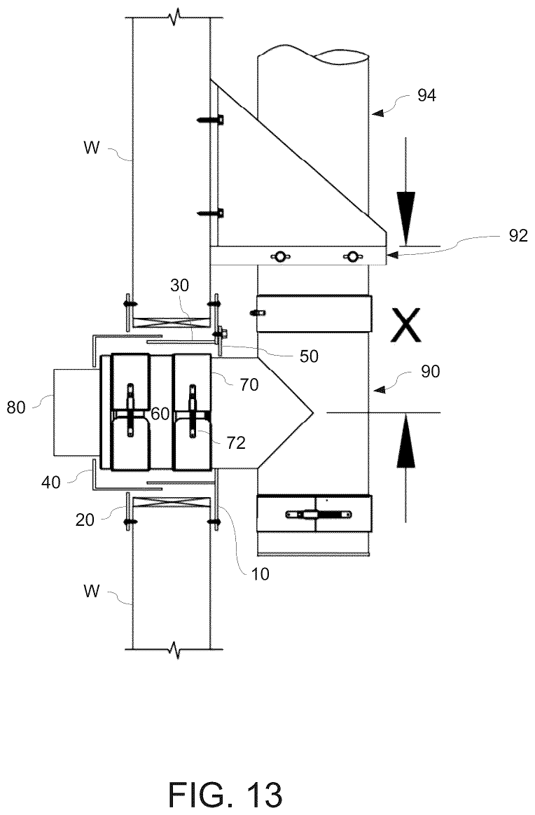

With reference to the drawings, FIG. 13 depicts an exemplary assembled wall assembly including a wall thimble assembly, as described herein, a chimney pipe adapter 80, a chimney pipe assembly 60, a tee assembly 90, a tee assembly support 92, and another pipe length 94, wherein the wall thimble assembly comprises a wall thimble alignment trim 10, a second trim 20, a first shield 30, a second shield 40, and an upper trim plate 50, and wherein the tee assembly support 92 is disposed above the tee assembly 90 and secured to a wall W. As shown in FIG. 13, the first profile portion of the wall alignment trim 10 can stabilize the chimney pipe assembly 60 and tee assembly 90 without temporary supports and establish an aligned location of the chimney pipe assembly 60 and tee assembly 90 with respect to the tee assembly support 92 based on a dimension X from a centerline of the chimney pipe assembly 60. In some embodiments, a first profile portion 14 of a wall alignment, as described herein, can align a chimney pipe 62, a chimney pipe assembly 60, and/or a tee assembly 90 with respect to a tee assembly support 92, as described herein, in a vertical and/or lateral dimension.

In some embodiments, a tee support 92, as described herein, may be positioned to abut (e.g., be positioned on top of) a top edge of the wall thimble alignment trim 10, as described herein. As a consequence, the first profile portion 14 of a wall thimble alignment trim 10, as described herein, can stabilize a chimney pipe 62, a chimney pipe assembly 60, and/or a tee assembly 90, as described herein, without temporary supports and center a length of the chimney pipe 62, the chimney pipe assembly 60, and/or the tee assembly 90 in a desired position with respect to the tee assembly support 92. In some embodiments, the first profile portion 14 of a wall thimble alignment trim 10, as described herein, can align a chimney pipe 62, a chimney pipe assembly 60, and/or a tee assembly 90, as described herein, with respect to a tee assembly support 92, as described herein, in a vertical and/or lateral dimension. In some embodiments, a wall thimble alignment trim 10, as described herein, may comprise one or more alignment features for aligning a tee assembly support 92, as described herein, with the wall thimble alignment trim 10. In some embodiments, a tee assembly support 92 may comprise one or more alignment features for aligning the tee assembly support 92 with a wall thimble alignment trim 10, as described herein. In some embodiments, a wall thimble alignment trim 10 and a tee assembly support 92, as described herein, can each include one or more corresponding alignment features for aligning the tee assembly support 92 with the wall thimble alignment trim 10. For example, a wall thimble alignment trim 10 and/or a tee assembly support 92, as described herein, can include one or more notches, tabs, projections, patterned edge(s), dimensional element(s), or the like that correspond to one or more corresponding one or more of a notch, projections, patterned edge, dimensional element, or the like of the other component. In some embodiments, one or more supplemental components (e.g., a tee assembly 90, a tee assembly support 92 and/or another pipe length 94) or other parts, as described herein, can be preassembled and positioned in place without the need to take measurements and/or determine mounting location since the first profile portion 14 establishes the placement and/or centering of the chimney pipe 62 or chimney pipe assembly 60 to which those supplemental components and/or other parts are connected.

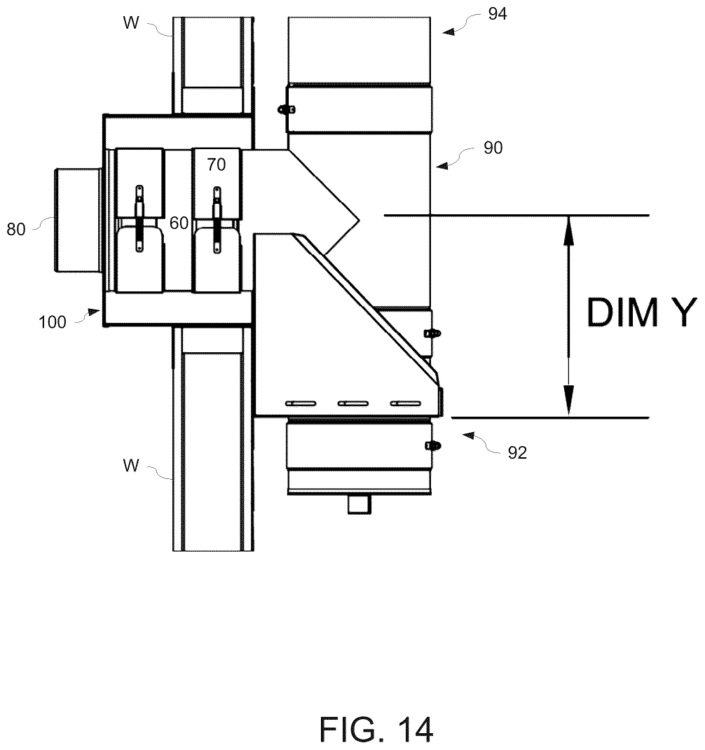

With reference to the drawings, FIG. 14 depicts an exemplary assembled wall assembly including a wall thimble assembly 100, a chimney pipe adapter 80, a chimney pipe assembly 60, a tee assembly 90, a tee assembly support 92, and another pipe length 94, wherein the tee assembly support 92 is disposed below the tee assembly 90 and secured to a wall W. As shown in FIG. 14, the first profile portion of the wall alignment thimble assembly 100 can stabilize the chimney pipe assembly 60 and tee assembly 90 without temporary supports and establish an aligned location of the chimney pipe assembly 60 and tee assembly 90 with respect to the tee assembly support 92 based on a dimension Y from a centerline of the chimney pipe assembly 60. In some embodiments, a first profile portion 14 of a wall alignment, as described herein, can align a chimney pipe 62, a chimney pipe assembly 60, and/or a tee assembly 90 with respect to a tee assembly support 92, as described herein, in a vertical and/or lateral dimension. In some embodiments, a tee support 92, as described herein, may be positioned to abut (e.g., be positioned below) a bottom/lower edge of the wall thimble alignment trim 10, as described herein. As a consequence, the first profile portion 14 of a wall thimble alignment trim 10, as described herein, can stabilize a chimney pipe 62, a chimney pipe assembly 60, and/or a tee assembly 90, as described herein, without temporary supports and center a length of the chimney pipe 62, the chimney pipe assembly 60, and/or the tee assembly 90 in a desired position with respect to the tee assembly support 92. In some embodiments, the first profile portion 14 of a wall thimble alignment trim 10, as described herein, can align a chimney pipe 62, a chimney pipe assembly 60, and/or a tee assembly 90, as described herein, with respect to a tee assembly support 92, as described herein, in a vertical and/or lateral dimension. In some embodiments, a wall thimble alignment trim 10, as described herein, may comprise one or more alignment features for aligning a tee assembly support 92, as described herein, with the wall thimble alignment trim 10. In some embodiments, a tee assembly support 92 may comprise one or more alignment features for aligning the tee assembly support 92 with a wall thimble alignment trim 10, as described herein. In some embodiments, a wall thimble alignment trim 10 and a tee assembly support 92, as described herein, can each include one or more corresponding alignment features for aligning the tee assembly support 92 with the wall thimble alignment trim 10. For example, a wall thimble alignment trim 10 and/or a tee assembly support 92, as described herein, can include one or more notches, tabs, projections, patterned edge(s), dimensional element(s), or the like that correspond to one or more corresponding one or more of a notch, projections, patterned edge, dimensional element, or the like of the other component. In some embodiments, one or more supplemental components (e.g., a tee assembly 90, a tee assembly support 92 and/or another pipe length 94) or other parts, as described herein, can be preassembled and positioned in place without the need to take measurements and/or determine mounting location since the first profile portion 14 establishes the placement and/or centering of the chimney pipe 62 or chimney pipe assembly 60 to which those supplemental components and/or other parts are connected.

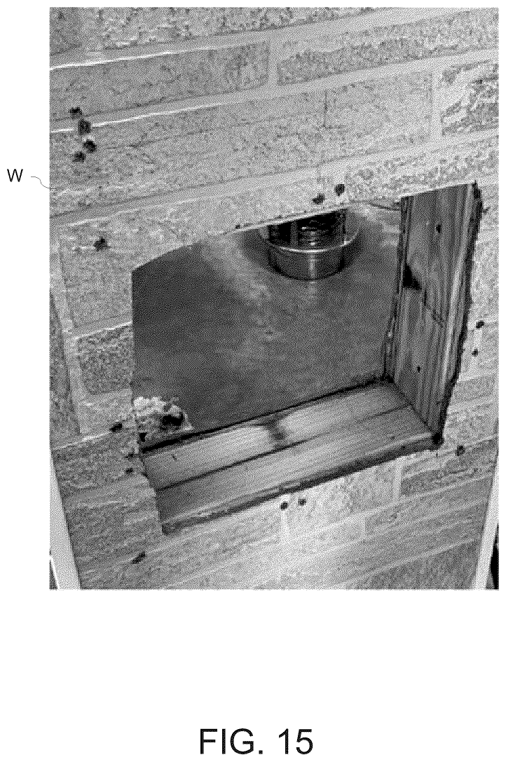

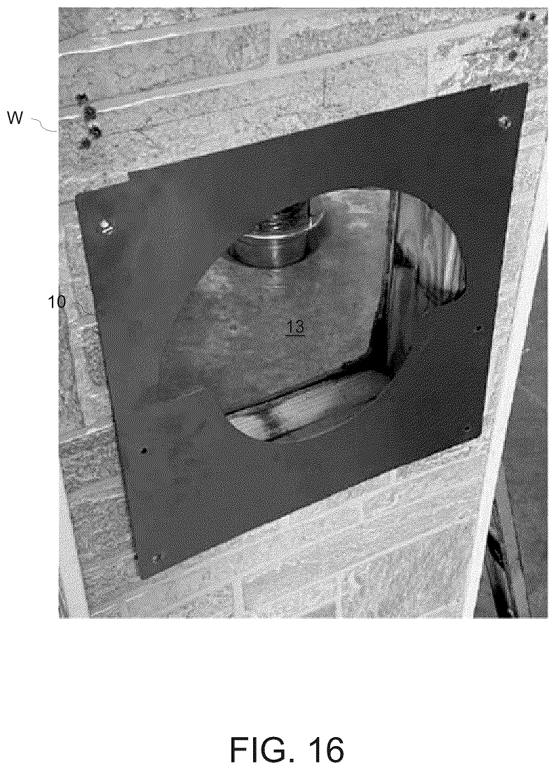

With reference to the drawings, FIGS. 15-18 depict an exemplary method of installing of a wall assembly including a wall thimble alignment trim 10, as described herein. As shown in FIG. 15 and FIG. 16, a method of installing a wall assembly may comprise a first step of installing a wall thimble alignment trim 10 over a rough-in opening of a wall W.

As shown in FIG. 16, an exemplary wall thimble alignment trim 10 comprises an opening 13 given formed from a first profile 14, a second profile 16, and a transitional section 15 provided between, and adjoining, the first profile portion 14 and the second profile portion 16. As shown in FIG. 16, the arrangement of the first profile 14 and the second profile 16 can provide sufficient clearance to permit the chimney pipe assembly 60, including one or more locking bands 70, tightening assemblies 72, flanges, screws, or one or more other parts or other obstructions associated therewith, to pass through the opening 13 of the wall thimble alignment trim 10 without interference.

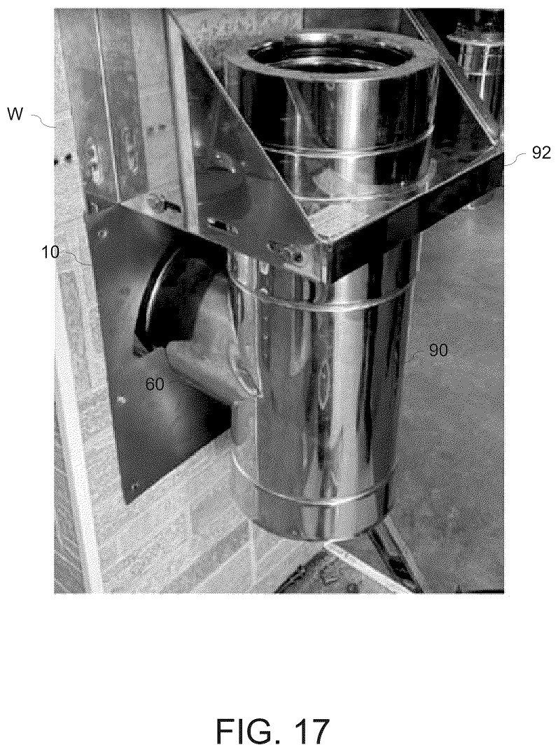

As shown in FIG. 17, after a portion of the chimney pipe assembly 60 which has an obstruction is passed through the opening 13 of the wall thimble alignment trim 10, a part of the chimney pipe assembly 60 can be lowered into and fit in the first profile 14 of the opening 13 of the wall thimble alignment trim 10. As shown in FIG. 17, the first profile portion 14 comprises a profile shape that corresponds to or is substantially equal to a pipe radius of the chimney pipe of the chimney pipe assembly 60. In some embodiments, a first profile portion 14 of the wall alignment trim 10, as described herein, can secure and align a position of a chimney pipe 62, a chimney pipe assembly 60, and/or tee assembly 90, as described herein, and a tee assembly support 92 can be positioned and secured to a wall W above the tee assembly 90.

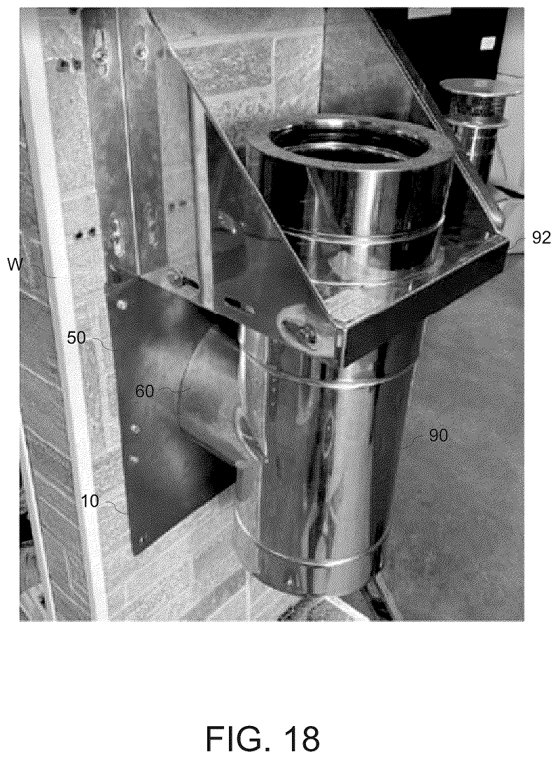

As shown in FIG. 18, after a part of the chimney pipe assembly 60 has been lowered into and fit in the first profile 14 of the opening 13 of the wall thimble alignment trim 10, an upper trim plate 50 configured to be coupled to a surface of the wall thimble alignment trim 10 to cover or close off the second profile portion 16 of the opening 13 can be provided. As shown in FIG. 18, the upper trim plate 50 can include a third profile portion configured to cooperate with the first profile portion 14 of the wall thimble alignment trim 10 to surround the chimney pipe assembly 60 and provide a finished appearance of the wall assembly.

As shown in FIGS. 15-18, the wall thimble alignment trim 10 can include one or more alignment features for aligning the tee assembly support 92 with the wall thimble alignment trim 10, such as a notch located at each corner of the upper edge of the wall thimble alignment trim 10. In FIGS. 15-18, the tee assembly support 92 can include one or more alignment features, such as one or more tabs (not visible in FIG. 17 and FIG. 18) for aligning the tee assembly support 92 with the notches of the wall thimble alignment trim 10. In some embodiments, only one of a wall thimble alignment trim 10 and a tee assembly support 92, as described herein, may comprise one or more corresponding alignment features for aligning the tee assembly support 92 with the wall thimble alignment trim 10. In embodiments, a wall thimble alignment trim 10 and/or a tee assembly support 92, as described herein, can include one or more notches, tabs, projections, patterned edge(s), dimensional element(s), or the like that correspond to one or more corresponding one or more of a notch, projections, patterned edge, dimensional element, or the like of the other component.

In the exemplary embodiments, a wall thimble assembly 100, as described herein, is directed to a chimney assembly, such as a residential chimney assembly, for example, for a wood burning stove, a pellet stove, or the like, which includes a wall thimble alignment trim 10 where the chimney passes through a combustible wall of a building structure to protect the wall from overheating. The wall structure is not limited to any particular wall structure and can include, for example, an interior wall, an exterior wall, or other types of structures for partitioning space, including combustible materials or non-combustible materials or various levels or ratings of combustibility. In some embodiments, the exemplary wall thimble assembly 100 and/or wall thimble alignment trim 10 can be provided and/or scaled for a chimney assembly, such as a commercial chimney assembly. The exemplary embodiments are not limited to a chimney assembly or a chimney pipe, and can include, for example, other penetrating elements, such as pipes, vent pipes or ducts, exhaust pipes or ducts, or the like.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

1. A wall thimble alignment trim for a wall thimble assembly, wherein the wall thimble alignment trim comprises:
a body having an opening, wherein the opening includes a first profile portion and a second profile portion, wherein the second profile portion has an opening area that is greater than an opening area of the first profile portion.

2. The wall thimble alignment trim of claim 1, wherein the first profile portion is a lower profile portion and the second profile portion is an upper profile portion.

3. The wall thimble alignment trim of claim 1, wherein the first profile portion and the second profile portion form a mushroom shape.

4. The wall thimble alignment trim of claim 1, wherein the first profile portion has a curved profile having a first radius and the second profile portion has a curved profile having a second radius, wherein the second radius is greater than the first radius.

5. The wall thimble alignment trim of claim 1, wherein the first profile portion has a different profile shape than the second profile portion.

6. The wall thimble alignment trim of claim 1, wherein one or both of the first profile portion and the second profile portion has a constant radius profile.

7. The wall thimble alignment trim of claim 1, wherein one or both of the first profile portion and the second profile portion has a variable radius profile.

8. The wall thimble alignment trim of claim 1, wherein one or both of the first profile portion and the second profile portion has a profile shape other than a radial profile shape or a curved profile shape.

9. The wall thimble alignment trim of claim 1, wherein the opening includes a transitional section between the first profile portion and the second profile portion.

10. The wall thimble alignment trim of claim 1, wherein the body is a trim plate.

11. The wall thimble alignment trim of claim 1, comprising an upper trim plate coupled to the body to cover or close off the second profile portion of the opening.

12. A wall thimble assembly comprising the wall thimble alignment trim of claim 1.

13. The wall thimble assembly of claim 12, further comprising:
one or more shields configured for a thickness of a wall;
a trim plate at first end of the one or more shields, wherein the wall thimble alignment trim is at a second end of the one or more shields.

14. The wall thimble assembly of claim 12, further comprising:
a first shield; and
a second shield, wherein the first shield and the second shield are telescopically adjustable with respect to each other.

15. The wall thimble assembly of claim 14, comprising:
a trim plate at first end of the first shield,
wherein the wall thimble alignment trim is at a second end of the second shield, the second end being opposite the first end of the first shield.
